(19) United States
(12) Patent Application Publication
(10) Pub. No.: US 2005/0067393 A1
(43) Pub. Date: Mar. 31, 2005

(54) Method and installation for laser beam cutting using a multiple-focus objective and a convergent/divergent nozzle

(76) Inventor: Matile Olivier, Paris (FR)

Correspondence Address: Air Liquide;Intellectual Property Department, 2700 Post Oak Blvd, Suite 1800, Houston, TX, 77056, US

(21) Appl. No.: 10/487,514

(22) PCT Filed: Jul. 12, 2002
(86) PCT No.: PCT/FR02/02478

(30) Foreign Application Priority Data
Aug. 22, 2001 (FR) 01/10998

(51) Int. Cl. B23K 26/06; B23K 26/38; B23K 26/14

(52) U.S. Cl. 219/121.75; 219/121.84

(57) ABSTRACT

A method and installation which provides for cutting a material with a laser beam using at least a multiple-focus optical means, such as a lens or the like, for focusing the laser beam in several separate focusing points in combination with a convergent/divergent nozzle through which passes the laser beam and also through which flows a gas stream assisting the laser beam.

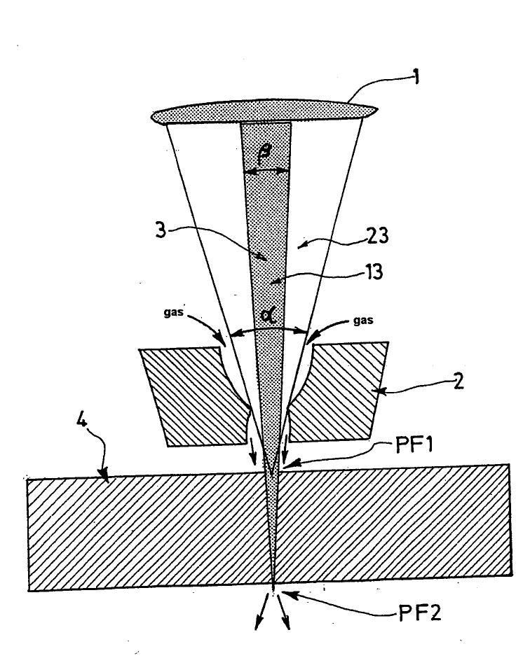

The present invention relates to a method of laser beam cutting which employs a means of making a multiple-focal-length optical beam converge, in particular a focusing means of the bifocal lens type, in order to focus the beam at several separate focal points, said means being combined with a nozzle having a specific convergent/divergent architecture, called hereafter a Laval nozzle, in order to deliver the stream of assistance gas for the cutting method.

Conventionally, during implementation of a method of cutting a material with a laser beam, the assistance gas, the primary role of which is to promote the ejection, by a kinetic effect, of the molten material by the laser beam, is fed in via a nozzle the internal geometry of which, in combination with the gas feed pressure of this nozzle, determines the characteristics of the gas flow above and in the cutting kerf and, in particular, the dynamic pressure at the entry of the cutting kerf, that is to say at the upper surface of the material facing the welding nozzle.

Moreover, when effective channeling of the assistance gas toward the workpiece to be cut is desired, it is known to use a nozzle with an axisymmetric internal profile of the convergent/divergent type, also called a Laval nozzle, since such a nozzle allows the gas that it delivers to be considerably accelerated thanks to a supersonic expansion occurring in the divergent part of the nozzle, thus generating a dynamic pressure greater than that obtained with a cylindrical nozzle for the same feed pressure and the same gas flow rate.

However, hitherto, owing to the particular geometry of this type of nozzle, in particular its greater length compared with a nozzle of conventional cylindrical type, and the fact that the kerf is necessarily far from the smallest cross section of the nozzle (the throat section), it is difficult, if not impossible, to house the caustic, that is to say the exterior envelope of a conventional beam delivered by a power laser (TEM₀₀ or TEM₀₁• mode), within the bore of said nozzle, without beam/nozzle wall contact, while still maintaining a correct position of the focal point relative to the workpiece to be cut.

It should be noted that any contact between the laser beam and the wall of the nozzle would heat up this wall, possibly resulting in accelerated impairment thereof, or even in certain cases its almost complete degradation, requiring therefore its frequent or anticipated replacement.

Consequently, this type of nozzle can be used in laser cutting only at the expense of considerable technical difficulties or non-optimal operation.

Thus, the use of a convergent/divergent nozzle with a conventional laser beam results:
either in the use of optics with a very long focal length, in order to allow the beam caustic to be contained within the nozzle, without contact with the walls, which means that there is only a low power density at the focal point;
or in the placing of the focal point at a non-optimal distance from the workpiece to be cut and in particular at too high a point, that is to say too close to the upper surface of the workpiece to be cut, which is the surface located facing the nozzle delivering the laser beam;
or in the use of a convergent/divergent nozzle with a very wide cross section at the throat, which means considerably increasing the consumption of assistance gas.

The object of the present invention is to propose a method of laser beam cutting with assistance gas that makes it possible to benefit from the advantages of using a Laval nozzle without having the drawbacks thereof, and to do so so as to be able to increase the cutting speed compared with a conventional method.

The solution of the invention is therefore a method of cutting a material (a workpiece to be cut) by a laser beam (3, 13, 23) employing at least one multiple-focus optical means (1) to focus the laser beam (3, 13, 23) at several separate focal points (FP1, FP2) in combination with a convergent/divergent nozzle (2) through which said laser beam (3, 13, 23) travels and a stream of laser-beam assistance gas flows.

Depending on the case, the method of the invention may include one or more of the following technical features:
the optical means is designed so as to obtain at least a first focal point (FP1), which is positioned near the upper surface of the workpiece to be cut, preferably so as to coincide with said upper surface, or in the thickness of the workpiece to be cut in a region close to said upper surface, and a second focal point (FP2) which is positioned near the lower surface of the workpiece to be cut and in the thickness of the latter or beyond said lower surface;
the optical means splits the laser beam into a central sub-beam and a peripheral sub-beam, the central sub-beam being focused at the second focal point (FP2) and the peripheral sub-beam being focused at the first focal point (FP1);
the assistance gas is selected from oxygen, nitrogen, argon, helium, hydrogen, carbon dioxide and mixtures thereof;
the material is a workpiece made of nonalloy or low-alloy steel, stainless steel, clad steel, aluminum or an aluminum alloy;
the multifocal optical means is chosen from lenses, mirrors and combinations thereof, preferably a bifocal lens or a combination of several lenses;
the thickness of the workpiece to be cut is between 0.8 mm and 20 mm, preferably from 2 to 12 mm;
the workpiece to be cut is selected from plates, sheets and tubes; and
the gas is at a pressure of 0.5 to 30 bar, preferably from 1 to 28 bar.

The invention also relates to an installation for laser beam cutting assisted by an assistance gas, capable of implementing a method according to the invention, which comprises:
at least one laser generator for generating at least one laser beam;
at least one multiple-focus optical means for splitting said laser beam into at least two laser sub-beams by focusing said laser sub-beams at at least a first focal point (FP1) and a second focal point (FP2) that differ from one another;
at least one convergent/divergent nozzle through which said laser sub-beams pass; and
at least one source of assistance gas for feeding said convergent/divergent nozzle with assistance gas.

As will have been apparent from the foregoing, the invention relies on the use of a combination of a convergent/divergent nozzle and a multifocal objective or lens, that is to say one having several focal lengths, thereby making it possible to advantageously combine the advantages of these two devices, in particular by a better distribution of the heat flux generated by the impact of the beam exiting from a lens, from an optic or from a multiple-focus objective, and by an improved kinetic effect resulting from the use of the nozzle with a convergent/divergent internal profile.

The caustic may, in the case of the invention, be perfectly confined within the bore of the nozzle without any risk of it coming into contact with the walls, since the spatial distribution of the laser beam is changed owing to the use of a multiple-focus lens, mirror, optic or objective.

The expression “multiple-focus lens, mirror, optic or objective” is understood to mean one or more optical devices for synchronously focusing several focal points, in general two separate points located along the axis of the nozzle orifice, by dividing the main laser beam emitted by the power laser source, for example a CO₂ or Nd:YAG laser, into several (usually two) intersecting sub-beams, as described by document EP-A-929 376, that is to say that the central sub-beam is focused below the peripheral sub-beam, in the thickness of the workpiece to be cut.

The principle of operation of a multiple-focus optical means or device is schematically as follows: however, for more detail, the reader may refer to document EP-A-929 376 (=WO 98/14302).

The main laser beam delivered by a laser beam generator is typically split into two sub-beams by means of a bifocal optical means so as to obtain a first focal point FP1 and a second focal point FP2 that lie along the longitudinal axis of the laser nozzle.

The first focal point FP1 arising from the larger angle of convergence (peripheral sub-beam) obtained with the bifocal optical means is positioned near the upper surface of the workpiece to be cut, preferably so as to coincide with said upper surface, or in the thickness of the material in a region near said upper surface.

Moreover, the second focal point FP2 arising from the smaller angle of convergence (central sub-beam) obtained with said bifocal optical means is positioned close to the lower surface of the workpiece, in the thickness of the material or beyond said lower surface.

In other words, the peripheral sub-beam and central sub-beam are coaxial, but have different angles of convergence.

The angles of convergence to be selected for each of the sub-beams may be chosen empirically by a person skilled in the art, in particular according to the length and the geometry of the nozzle with which the laser cutting device is equipped, the thickness of the material to be cut, the choice of the site of focusing of each of the points, etc.

### COMPARATIVE EXAMPLES

As examples, Tables I and II below allow comparison of the results obtained with various combinations of optics (monofocal or multifocal optics) and of nozzles (cylindrical or convergent/divergent nozzle) when implementing a laser beam cutting method with an assistance gas using these various lens/nozzle combinations.

During these trials, a stainless steel plate 3 mm in thickness was cut with a laser beam delivered by a CO₂-type laser generator with a power of 1500 W using pure nitrogen as laser beam assistance gas and with various lens/nozzle combinations, as detailed in Tables I and II.

Trials A to D of Table I were carried out keeping the pressure and the flow rate of the cutting gas constant (flow rate=15 m³/h), while those (Trials E to H) given in Table II were carried out keeping the cutting speed constant (=2.2 m/min).

All the other operating conditions (such as nozzle/workpiece distances, focal point positions, pre-gas and post-gas duration, etc.) were the same however.

The gas used was nitrogen, available from Air Liquide with the commercial name LASAL 2001.

TABLE I
Cutting with constant pressure and gas flow
rate

| | Trial A | Trial B | Trial C | Trial D |
|---|---|---|---|---|
| | prior art | prior art | prior art | invention |
| Lens type | Conventional | Conventional | Bifocal | Bifocal |
| | monofocal | monofocal | lens | lens |
| | lens | lens | | |
| Type of | Convergent | Convergent/ | Convergent | Convergent/ |
| nozzle | | divergent | | divergent |
| Cutting gas | Nitrogen | Nitrogen | Nitrogen | Nitrogen |
| Cutting | 2.2 m/min | Not | 2.7 m/min | 3.0 m/min |
| speed | | applicable | | |
| Gas | 15 m³/h | Not | 15 m³/h | 15 m³/h |
| consumption | | applicable | | |

TABLE II
Cutting with constant cutting speed

| | Trial E | Trial F | Trial G | Trial H |
|---|---|---|---|---|
| | prior art | prior art | Prior art | invention |
| Lens type | Conventional | Conventional | Bifocal | Bifocal |
| | monofocal | monofocal | lens | lens |
| | lens | lens | | |
| Type of | Convergent | Convergent/ | Convergent | Convergent/ |
| nozzle | | divergent | | divergent |
| Cutting gas | Nitrogen | Nitrogen | Nitrogen | Nitrogen |
| Cutting | 2.2 m/min | Not | 2.2 m/min | 2.2 m/min |
| speed | | applicable | | |
| Gas | 15 m³/h | Not | 14 m³/h | 10 m³/h |
| consumption | | applicable | | |

These trials clearly demonstrate that by using a (bifocal optic/Laval nozzle) combination according to the invention in laser beam cutting, either an increase in the cutting speed is obtained, when flow rates identical to those used with a conventional device are employed, or a reduction in the consumption of assistance gas needed, for a cutting speed identical to that used for a conventional device, is obtained.

The cutting head of a laser cutting installation according to the invention is shown schematically in the appended figure, said head comprising, in combination, one or more, transparent or reflecting, optical means 1, for example a bifocal lens making it possible to obtain synchronously two separate focal points FP1, FP2 from a main laser beam 3 split into two sub-beams by said lens 1, and a Laval nozzle 2 with a convergent/divergent profile so as to allow a workpiece 4 to be cut.

Such an installation comprises at least one CO₂-type or Nd:YAG-type laser generator for generating the laser beam 3, a convergent/divergent nozzle 2 delivering the assistance gas, through which nozzle the two laser sub-beams 13, 23 arising from the splitting of the main laser beam 3 pass, at least one optical means 1 for splitting the laser beam 3 into a first laser sub-beam 13 and a second laser sub-beam 23 so as to focus it at two focal points FP1, FP2, and at least one source of laser beam assistance gas feeding the nozzle 2 with assistance gas, the injection of the assistance gas into the nozzle 2 taking place conventionally via one or more gas inlet orifices.

Optical means 1 of the lens type having several focal points that can be used within the context of the present invention are described in document WO-A-98/14302 and commercially available from V&S.

However, other optical means may also be used, provided that these optical means allow focusing at two focal points FP1 and FP2 such that the first focal point FP1 arising from the larger angle of convergence, in this case the angle α of the sub-beam 23, is positioned close to the upper surface of the workpiece 4 to be cut, preferably so as to coincide with said upper surface, or in the thickness of the material in a region near said upper surface, whereas the second focal point FP2 arising from the smaller angle of convergence, in this case the angle β of the sub-beam 13 is positioned close to the lower surface of the workpiece 14 in the thickness of the material, or beyond said lower surface.

This type of focusing is also called cross focusing, since the two sub-beams intersect.

As explained above, the nozzle 2 is a Laval nozzle with a convergent/divergent internal profile having, for example, a diameter at the throat of 0.5 mm to 3 mm and a length of the convergent/divergent section from 1 mm to 6 mm. Such nozzles, with the internal profile matched to the geometry of a beam with multiple focal points and matched to the desired pressure/flow rate conditions, can be produced on an industrial scale by conventional machining means.

The present invention is applicable to the cutting of nonalloy and low-alloy steels, stainless steels, clad steels, aluminum and aluminum alloys.

1-10. (canceled)

11. A method of cutting a material by a laser beam comprising:
a) introducing a workpiece to be cut, comprised of said material, said workpiece comprising an upper surface and a lower surface;
b) employing at least one multiple-focus optical means to focus the laser beam on to at least two separate focal points, said optical means comprising splitting said laser beam into a central sub-beam and a peripheral sub-beam, said central sub-beam being focused upon a second focal point and said peripheral sub-beam being focused upon a first focal point;
c) designing said optical means to position said first focal point approximately upon said upper surface of said workpiece, and to position said second focal point approximately upon the lower surface of said workpiece; and
d) employing a convergent/divergent nozzle through which said laser travels coincident with and a stream of laser-beam assistance gas.

12. The method as claimed in claim 11, wherein said first focal point is in the thickness of the workpiece in a region close to said upper surface.

13. The method as claimed in claim 11, wherein said second focal point is in the thickness of the workpiece in a region close to said lower surface.

14. The method as claimed in claim 11, wherein said multiple-focus optical means is selected from the group consisting of lenses, mirrors, and combinations thereof.

15. The method as claimed in claim 11, wherein said optical means is a bifocal lens or a combination of several lenses.

16. The method as claimed in claim 11, wherein said assistance gas is selected from the group consisting of oxygen, nitrogen, argon, helium, hydrogen, carbon dioxide, and mixtures thereof.

17. The method as claimed in claim 11, wherein said workpiece is comprised of material selected from the group consisting of non-alloy steel, low-alloy steel, stainless steel, clad steel, aluminum, and aluminum alloy.

18. The method as claimed in claim 11, wherein the thickness of said workpiece is between 0.8 mm and 20 mm.

19. The method as claimed in claim 18, wherein the thickness of said workpiece is between 2 and 12 mm.

20. The method as claimed in claim 11, wherein the workpiece to be cut is selected from the group consisting of plates, sheets, and tubes.

21. The method as claimed in claim 11, wherein said laser-beam assistance gas is at a pressure of 0.5 to 30 bar.

22. The method as claimed in claim 21, wherein said laser-beam assistance gas is at a pressure of 1 to 28 bar.

23. An apparatus for cutting a material by a laser beam comprising:
a) a laser beam;
b) a laser beam assistance gas;
c) a multiple-focus optical means, said multiple-focus optical means having at least two focal points, said focal points comprising a first focal point and a second focal point, said multiple-focus optical means splitting said laser beam into a central sub-beam and a peripheral sub-beam;
d) a workpiece to be cut, said workpiece comprising an upper surface and a lower surface, said workpiece positioned such that said first focal point is approximately on said upper surface, and said second focal point is approximately on said lower surface; and
e) a convergent/divergent nozzle, said nozzle positioned such that said laser-beam assistance gas, said central sub-beam and said peripheral sub-beam pass through said nozzle and contact said workpiece.

24. An apparatus as claimed in claim 23, wherein said multiple-focus optical means is selected from the group consisting of lenses, mirrors, and combinations thereof.

25. An apparatus as claimed in claim 23, wherein said optical means is a bifocal lens or a combination of several lenses.

26. An apparatus as claimed in claim 23, wherein said assistance gas is selected from the group consisting of oxygen, nitrogen, argon, helium, hydrogen, carbon dioxide and mixtures thereof.

27. An apparatus as claimed in claim 23, wherein said workpiece is comprised of material selected from the group consisting of non-alloy steel, low-alloy steel, stainless steel, clad steel, aluminum, and aluminum alloy.

28. An apparatus as claimed in claim 23, wherein the thickness of said workpiece is between 0.8 mm and 20 mm.

29. An apparatus as claimed in claim 28, wherein the thickness of said workpiece is between 2 and 12 mm.

30. An apparatus as claimed in claim 23, wherein the workpiece to be cut is selected from the group consisting of plates, sheets and tubes.

31. An apparatus as claimed in claim 23, wherein said laser-beam assistance gas is at a pressure of 0.5 to 30 bar.

32. An apparatus as claimed in claim 31, wherein said laser-beam assistance gas is at a pressure of 1 to 28 bar.
